(19) United States
(12) Patent Application Publication
(10) Pub. No.: US 2026/0246995 A1
(43) Pub. Date: Aug. 20, 2026

(54) SYNCHRONIZING MUSIC BEATS AND ANIMATION EFFECTS

(71) Applicant: Lemon Inc., Grand Cayman (KY)

(72) Inventors: Conghao Liu, Beijing (CN); Siyao Yang, Los Angeles, CA (US); Weikai Li, Los Angeles, CA (US); Yunpeng Jing, Los Angeles, CA (US); Xuan Tang, Los Angeles, CA (US); Joseph Macek, Los Angeles, CA (US)

(21) Appl. No.: 19/054,415

(22) Filed: Feb. 14, 2025

(51) Int. Cl. H04N 21/43; H04N 21/431; H04N 21/81; H04N 21/8547

(52) U.S. Cl. CPC H04N 21/43072; H04N 21/4312; H04N 21/8113; H04N 21/8547

(57) ABSTRACT

A method for synchronizing music and animation effects in a video includes, at a computing system, automatically determining, based on one or more music beat timing parameters for a music track, a plurality of beat timestamps for a plurality of music beats, wherein the music track is selected for concurrent playback with a video track as part of an output video. Based on the plurality of beat timestamps, a plurality of animation start times are automatically determined for initiating one or more animation effects selected for playback as part of the output video. The output video is output, wherein the music track, the video track, and the one or more animation effects are synchronized such that the one or more animation effects are played at the plurality of animation start times during playback of the output video.

### BACKGROUND

The creation and playback of edited videos that integrate user-selected music and text elements have become increasingly common in various multimedia applications. Such videos may be used for personal expression, advertising, social media content, entertainment, etc. Video editing software may be used to add selected music and text elements to an existing video track, facilitating the output of an edited video composition.

### SUMMARY

A method for synchronizing music and animation effects in a video includes, at a computing system, automatically determining, based on one or more music beat timing parameters for a music track, a plurality of beat timestamps for a plurality of music beats, wherein the music track is selected for concurrent playback with a video track as part of an output video. Based on the plurality of beat timestamps, a plurality of animation start times are automatically determined for initiating one or more animation effects selected for playback as part of the output video. The output video is output, wherein the music track, the video track, and the one or more animation effects are synchronized such that the one or more animation effects are played at the plurality of animation start times during playback of the output video.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1A schematically shows an example computing system used to synchronize video animation effects with a digital music track.

FIG. 1B schematically depicts various example beat timing parameters associated with a digital music track.

FIGS. 2A, 2B, 2C, and 2D schematically illustrate example animation effects synchronized to music beats during video playback.

FIGS. 3A, 3B, and 3C schematically illustrate example text animation effects synchronized to music beats during video playback.

FIGS. 4A, 4B, and 4C schematically illustrate example text animation effects synchronized to music beats during video playback.

FIG. 5 depicts a timeline of animation start times relative to music beat timestamps of a music track.

FIG. 6 illustrates an example method for synchronizing music and animation effects during video playback.

FIG. 7 schematically shows an example computing system.

### DETAILED DESCRIPTION

Manually synchronizing graphical animation effects with music beats in a video can be a challenging and time-consuming process. Precise alignment requires careful timing of animation start points to match the beats of a selected music track, which can be difficult to accomplish, particularly for those without expertise using video editing software. This difficulty increases with the complexity of the selected animation effects. Furthermore, some approaches to music synchronization do not adequately support smooth navigation, or “seeking,” along the video timeline. As a result, disruptions may occur in the playback of animations when a user jumps to a specific timestamp in the video.

Accordingly, the present disclosure describes techniques for automatically synchronizing music and animation effects for a digital video. A computing system determines beat timestamps for a digital music track based on one or more music beat timing parameters associated with the music track, such as the time interval between each beat of the music. These beat timestamps are used to automatically determine animation start times for initiating animation effects, such as text animations or other graphical effects, which have been selected for inclusion in the output video. In other words, the animation effects are synchronized with the beats of the music track. As a result, when the output video is played back (e.g., in a video editor timeline, or in a media player application), the animation effects are played at their corresponding animation start times, which themselves were automatically determined based on the timing of the music beats in the selected music track. Furthermore, the animation effects may be consistently displayed even if a user navigates to an arbitrary selected timestamp along the video timeline.

The techniques described herein provide several technical benefits. By automating the synchronization of music and animation effects, the system reduces the need for manual alignment, improving efficiency and accessibility for users. Additionally, the ability to seek along the video timeline without disrupting ongoing animations enhances the playback experience and ensures visual consistency. These improvements are particularly useful in video editing software, multimedia presentations, and other applications where synchronized audio-visual content is desirable.

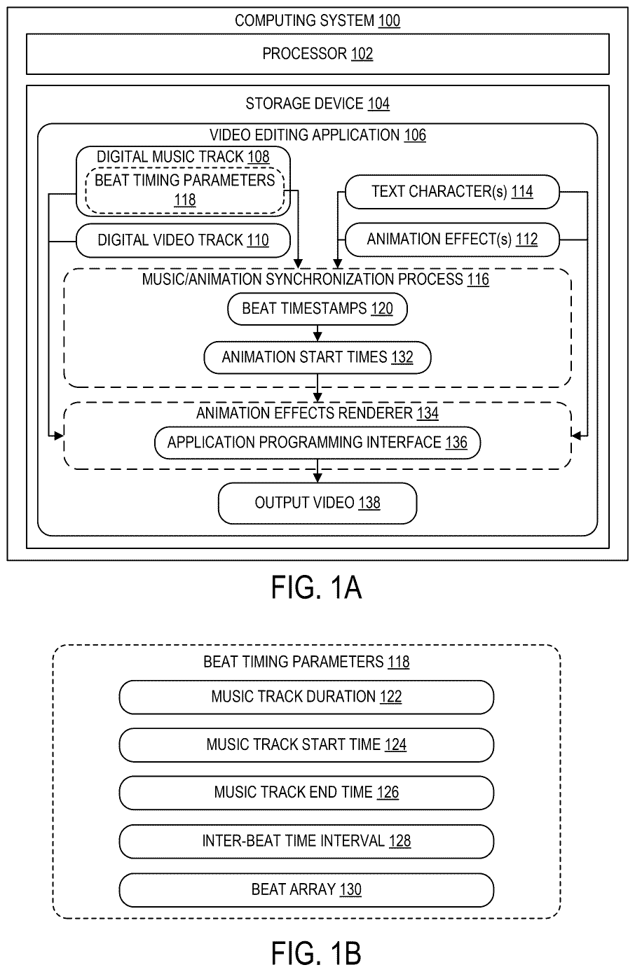

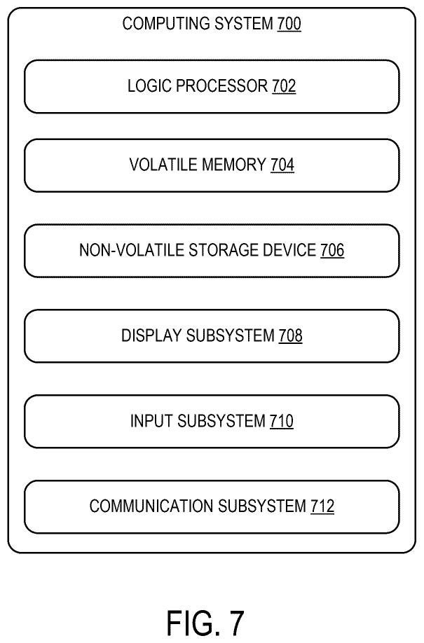

FIG. 1A schematically shows an example computing system 100, which includes a processor 102 and a storage device 104. The computing system may take any suitable form, having any suitable capabilities, hardware configuration, and form factor. As non-limiting examples, the computing system may be implemented as a personal computer (e.g., desktop, laptop), mobile computing device (e.g., smartphone, tablet), server computing device, etc. In some examples, computing system 100 may be implemented as computing system 700 described below with respect to FIG. 7.

The processor may take the form of any suitable computer logic component—e.g., central processing unit (CPU), graphics processing unit (GPU), application specific integrated circuit (ASIC), etc. In some examples, processor 102 may be implemented as logic processor 702 described below with respect to FIG. 7. Similarly, the storage device may take the form of any suitable computer hardware useable for storing data. In some examples, storage device 104 may be implemented through either or both of the volatile memory 704 and the non-volatile storage device 706 described below with respect to FIG. 7.

In FIG. 1A, the computing system is used to implement a video editing application 106. A video editing application may be executed directly on a client computing device (e.g., on a personal laptop, desktop, tablet, or smartphone), and/or implemented as part of a web application (e.g., executed by a server computing system and accessed through a web browser or other software application). In general, video editing applications refer to software tools that allow users to manipulate video content by combining various media elements, such as video tracks, audio tracks, images, text, and/or animation effects. These applications may provide various editing features for trimming, cutting, and rearranging video segments, as well as adding transitions, overlays, and synchronized visual or audio effects. As will be described in more detail below, users may import a digital video track, incorporate a selected music track, and apply visual elements such as text or animations to create an edited output video. In other words, the digital music track may be selected for concurrent playback with the digital video track as part of an output video, along with one or more selected animation effects.

In the example of FIG. 1, the video editing application is used to generate an output video that combines a digital video track, a digital music track and one or more selected animation effects. For instance, as will be described in more detail below, the animation effects may be synchronized to the selected music track, such that each animation effect begins at a respective animation start time, and the animation start time is determined based at least in part on the timings of music beats within the music track. As one example, as a song plays, a group of text characters forming a word may increase in size on each beat of the song. To this end, in FIG. 1, a digital music track 108, a digital video track 110, and a set of one or more animation effects 112 are each input to a music and animation synchronization process 106, which will be described in more detail below.

The digital music track may take any suitable form, and may be selected in any suitable way. For instance, the digital music track may have any suitable length, bitrate, sample rate, codec, etc. In some examples, the digital music track may be provided by a user—e.g., input to the video editing application as an audio file that is stored by the computing system and/or retrieved over a computer network. Additionally, or alternatively, in some examples, the video editing application may include a library of music tracks available for selection. For instance, the video editing application may be provided as part of a video distribution platform that facilitates users editing and uploading their edited videos. As such, in some cases, the digital music track may be selected from a list of multiple available digital music tracks—e.g., public domain music, and/or music tracks that have been licensed by the video distribution platform.

The present disclosure primarily focuses on music tracks that have a rhythmical pattern based on music beats. Such beats may be separated by any suitable time interval, and this interval may change over the duration of the music track (e.g., tempo changes). In some examples, the beats may be arranged in a recurring beat pattern (e.g., a musical “measure”), such that each beat has a different position within the recurring pattern. For instance, in some types of music, the first beat of each measure may have relatively more prominence than other beats in the measure. Thus, as will be described in more detail below, animation start times may in some cases correspond to different beat positions within the recurring beat pattern. As one example, an animation effect may be applied that triggers on the second and fourth beats of each musical measure. In some cases, the recurring beat pattern may change over the duration of the music track (e.g., a musical time signature change).

Similarly, the digital video track may take any suitable form, and be received from any suitable source. For instance, the digital video track may have any suitable length, resolution, bitrate, codec, etc. Similarly, it may in some cases be provided by a user—e.g., as a video file stored on the computing device and/or retrieved over a computer network. Additionally, or alternatively, the digital video track may be associated with a video distribution platform as discussed above. For instance, the digital video track may be included in a library of video tracks available for use by the user of computing system 100 and/or all users of the video distribution platform. Additionally, or alternatively, the digital video track may include video content uploaded by another user. For instance, the user of computing system 100 may be “sharing” or “reposting” content uploaded by another user of the video distribution platform while adding their own modification or customization—e.g., the addition of a selected music track, selected animation effects, text characters, additional video content, etc.

In FIG. 1A, the computing system is being used to add one or more selected animation effects 112 to the digital video track and digital audio track. The animation effects may be selected and/or otherwise specified in any suitable way. For instance, in some examples, the video editing application may include a predefined library of one or more animation effects that can be applied to digital video tracks.

“Animation effects” may refer to any of a wide variety of different graphical effects. In general, an animation effect refers to any graphical content that changes over time and is added to the digital video track during video editing. For instance, animation effects may include adding animated graphics to the digital video track (e.g., simulated fire effects, rain, snow, cartoon characters), moving images or objects along defined paths, resizing or rotating objects, applying fade-in or fade-out transitions, color transitions, filters (e.g., sepia or grayscale), morphing effects that transform shapes or images, etc.

In some examples, animation effects may be applied to a plurality of text characters (e.g., letters, numbers, symbols, emoji, words) selected for display as part of the output video. For instance, in FIG. 1A, the animation effects are being applied to a plurality of text characters 114. These text characters may be specified in any suitable way—e.g., typed and/or otherwise selected by a user for inclusion in the output video, and/or automatically output by a software application (such as a language model).

Text-based animation effects may include moving text across the screen (e.g., scrolling, sliding, or bouncing), changing the size of text (e.g., scaling up or shrinking), rotating or flipping text, dynamically transitioning text colors or opacity (e.g., fading in or out), letter-by-letter typing effects, font style changes, and/or distortions, such as warping or vibrating text. In other words, text-based animation effects may include one or more of changing a size, a shape, a position, an orientation, a color, an opacity, and a font type of a plurality of text characters.

In the example of FIG. 1A, the digital music track 108, digital video track 110, selected animation effects 112, and text characters 114 are input to a music and animation synchronization process 116, which synchronizes the animation effects with music beats of the digital music track. To this end, based on one or more beat timing parameters 118 for the digital music track 108, the computing system automatically determines a plurality of beat timestamps 120 for a plurality of music beats of the digital music track. These may specify the moments within the music track at which each beat occurs—e.g., defined relative to the starting point of the music track.

The beat timing parameters may take any suitable form. In some examples, the beat timing parameters may directly specify the beat timestamps for the music track. For instance, the beat timing parameters may include a list of timestamp values representing the start times of the music beats within the music track. Alternatively, the beat timing parameters may include information usable to derive the beat timestamps, without specifying the beat timestamps directly. Some music tracks may include beats that are separated by a fixed time interval that does not change over the duration of the music track. Thus, in such cases, the beat timestamps could be derived based only on an indication of the inter-beat time interval, which can beneficially reduce the amount of data used to represent the beat timing parameters (e.g., as compared to a scenario where a list of timestamps is provided).

In some cases, the beat timing parameters may include additional or alternative information to the inter-beat time interval. FIG. 1B schematically shows various examples of parameters that may be included among the beat timing parameters 118. These include a duration 122 of the digital music track, a start time 124 of the digital music track, an end time 126 of the digital music track, an inter-beat time interval 128, and a beat array 130 of the plurality of music beats. The beat array may specify a recurring beat pattern of the music beats—e.g., in cases where there are four beats per musical measure, then the beat array may specify the four-beat recurring pattern as [1, 2, 3, 4], or in another suitable way. In some cases, two or more beat arrays may be provided, in cases where the recurring beat pattern changes over the duration of the digital music track.

The beat timing parameters may in some cases be derived from the digital music track by the computing system. For instance, the computing system may apply a timing analysis algorithm to the digital music track (e.g., to identify recurring peaks within an audio waveform corresponding to percussion strikes and/or other repeating sounds) to thereby determine the beat timing parameters and/or directly estimate the beat timestamps. Additionally, or alternatively, the beat timing parameters may be retrieved from another source, such as over a computer network. For instance, as discussed above, the digital music track may in some cases be selected from a music library provided by a video distribution platform. In such cases, the video distribution platform may additionally provide the beat timing parameters and/or beat timestamps for the music tracks available for user selection.

The beat timing parameters may be specified in any suitable way. In some examples, the beat timing parameters may be encoded within the digital music track—e.g., in the form of metadata. In some examples, the beat timing parameters may be specified in a separate digital file, such as a JSON file, as one non-limiting example.

Returning to FIG. 1A, as shown, the computing system automatically determines a plurality of animation start times 132 based at least in part on the plurality of beat timestamps 120. The animation start times may have any suitable relationship with respect to the beat timestamps, depending on the nature of the animation effects being applied. In some examples, one or more of the animation start times are the same as one or more of the beat timestamps. In other words, one or more animations may begin at the same time as one or more corresponding beats within the music track. As one example, text characters may increase in size and/or change position on each beat.

Additionally, or alternatively, one or more of the animation start times may differ from corresponding beat timestamps by predetermined amounts. For example, one animation effect may cause a symbol to bounce up and down along the screen as the video track plays, and the symbol reaches predetermined positions along its movement path on each beat. As another example, a set of text characters may gradually grow and shrink as the video track plays, such that the text characters begin at a default size, reach their maximum size on each musical beat, and then shrink back to their default size again. Thus, in some examples, the animation effect may begin one or more frames before a corresponding beat timestamp, such that the animation effect has progressed to a certain state (e.g., size, shape, on-screen position) when the beat occurs.

In some examples, a given animation effect may be repeated two or more times over the duration of the video track. For instance, text characters may change in size on each of several beats of the music track. Thus, in some examples, two or more of the animation start times may correspond to the same selected animation effect—e.g., separate animation start times may correspond to each beat on which the text characters change in size. In other words, a selected animation effect may be associated with two or more different animation start times at different points along the video track.

In cases where two or more animation effects are selected for the same digital video track, then the animation start times may be specific to the different animation effects. For instance, a first animation effect may cause text characters to change size, while another animation effect may cause text characters to change their position. Thus, the set of animation start times may include one or more start times specific to the first animation effect (e.g., musical beats where the text changes size), and one or more start times specific to the second animation effect (e.g., musical beats where the text changes position).

Furthermore, in some cases, the animation start times may be specific to different graphical objects (such as images and text characters) to which the animation effects are applied. In such cases, the computing system may generate separate animation start times for each graphical object—e.g., a first animation start time pertaining to object A, and a second animation start time pertaining to object B. This may be the case when different animation effects are applied to the different graphical objects, and/or in cases where the same animation effect is applied to the different graphical objects at the same or different times. In some scenarios, the same and/or different animation effects may be applied to two or more different graphical objects at the same time, and this may be indicated by different animation start times each specifying the same timestamp, but applying to different graphical objects and/or animation effects.

In cases where animation effects are applied to text characters (e.g., text characters 114), then the plurality of text characters may in some cases be divided into two or more character groups. These may, for instance, correspond to different words—e.g., one character group is one word, and another character group is a different word. It will be understood that character groups need not correspond to words, but rather can include any arbitrary groupings of one or more text characters.

In cases where text characters are divided into character groups, then the same animation effect may be applied to the different character groups at the same or different times. In other words, one or more selected animation effects may be applied to the two or more character groups at different animation start times of the plurality of animation start times. For instance, two different words (or other character groups) may change colors in a flashing effect on alternating beats, such that one-word flashes on a first beat, the other word flashes on the second beat, and so on.

Additionally, or alternatively, two or more different animation effects may be applied to the different character groups, such that different animation effects are applied to each character group. For instance, one word may change colors in a flashing effect on every beat, while another word changes its size every two beats.

In some examples, different character groups may be represented by different index values in a character group index. Thus, different animation start times may additionally be associated with different character groups, represented by different index values. For instance, some animation start times may pertain to a first character group represented by a first index value, and other animation start times may pertain to a second character group, represented by a second index value. In this manner, animation effects may be applied to the different character groups at different times.

In any case, in FIG. 1A, the music and animation synchronization process 116 outputs a plurality of animation start times 132. These may in some cases be provided to an animation effects rendering process, which applies the selected animation effects to the digital video at the specified animation start times. In some examples, the animation effects rendering process may be isolated from the music synchronization process—e.g., it may be a general animation effects renderer of the video editing application, which is useable even in scenarios where no music synchronization is performed. For instance, in FIG. 1A, the animation start times 132 are received by an animation effects renderer 134 via an application programming interface (API) 136. This may beneficially enhance compatibility of the techniques described herein with existing animation rendering processes, as such processes do not need to be modified to support synchronization of animation effects with music beats. Rather, the animation start times may be passed to the existing animation effects renderer of the video editing application using its API.

In general, the digital music track 108, digital video track 110, animation effects 112, and animation start times 132 are used together to generate an output video 138. This is done such that the digital music track, the digital video track, and the animation effects are synchronized, meaning the one or more animation effects are played at the plurality of animation start times during playback of the output video. As discussed above, the animation start times are based on the plurality of beat timestamps of the digital music track, but each animation effect may have any suitable predefined relationship with respect to its corresponding beat timestamps. For instance, some animation effects may begin on each beat timestamp, while some animation effects may be offset from the beat timestamps by predefined amounts, such that the animation effect has a certain progression state (e.g., text characters reaching a certain size or position) on its corresponding beat timestamps. In some examples, progression states of the animation effect may be defined by animation keyframes—e.g., a particular keyframe of the animation effect should coincide with a corresponding beat timestamp.

In some cases, outputting the output video may include playing the digital video track in a timeline of the video editor, while the digital music track and animation effects are also played. For instance, this may occur when the user is previewing the changes and/or effects they have applied to the digital video track. Additionally, or alternatively, outputting the output video may include rendering the output video as a standalone digital file—e.g., such that the video file can be played in a separate media player application and/or uploaded to a video distribution platform. For instance, the rendered video file may be output by animation effects renderer 134 of the computing system, as discussed above. In general, the output video may be “output” in any suitable way. This can include storing data representing the output video in internal and/or removable storage, writing the data to a file, transmitting the data over a computer network, etc.

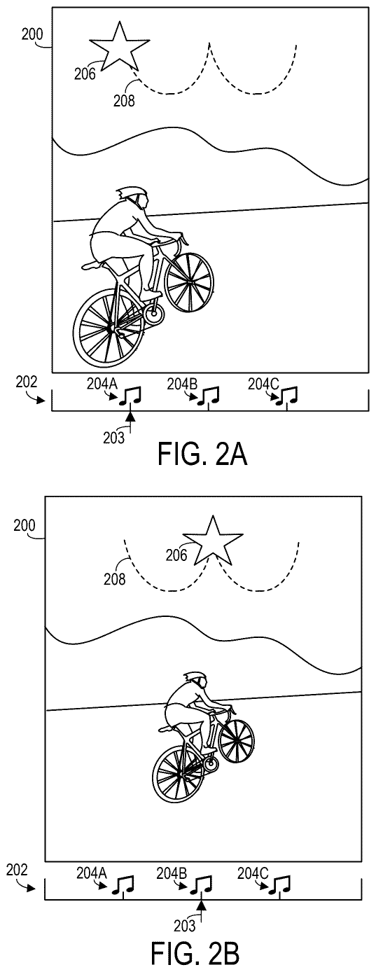

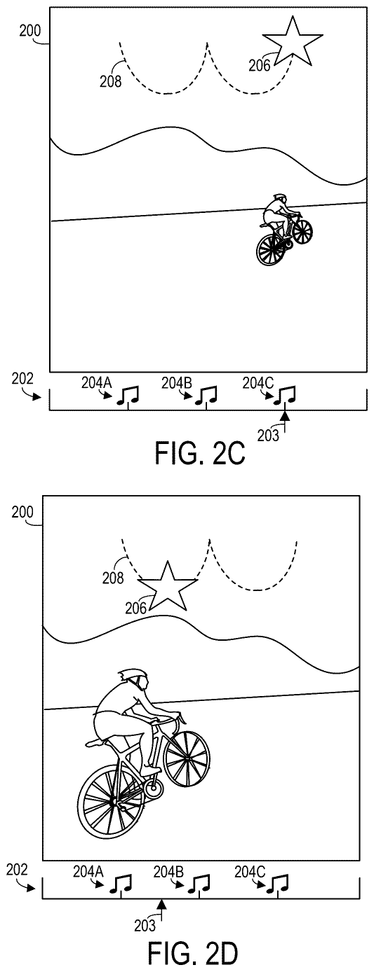

Various examples of synchronized animation effects are illustrated with respect to FIGS. 2A-2D, 3A-3C, and 4A-4C. FIG. 2A shows an example output video 200, which is generated based on a digital video track, a digital music track, and one or more selected animation effects as discussed above. The output video is in the process of being played, as indicated by reference timeline 202. The position of a progress indicator 203 along the reference timeline indicates the playback progress of the video. Additionally, the positions of music beats are indicated along the reference timeline by beat indictors 204A, 204B, and 204C. In other words, these indicate the relative positions of the beat timestamps along the timeline of the output video. It will be understood that the reference timeline 202, progress indicator 203, and beat indicators 204A-C are provided for the sake of illustration and need not be displayed during actual playback of the output video.

Furthermore, in FIG. 2A, an animation effect is being played during the progress of the output video. This includes a star symbol 206, which moves along an animation path 208 during the playback of the output video. In other words, in this example, the star symbol “bounces” during the playback of the video by following the animation path. This animation effect was synchronized with the music track selected for inclusion in the output video according to the techniques described above with respect to FIG. 1. In other words, in this example, the speed at which the star symbol “bounces” along its animation path was determined based at least in part on the timing of the music beats of the music track. At the playback position depicted in FIG. 2A, the progress indicator 203 coincides with the first beat 204A, and thus the star symbol is still at its leftmost position along the animation path.

Turning now to FIG. 2B, the playback time of the output video has advanced, as indicated by the progress indicator 203. In FIG. 2B, the progress indicator now coincides with the second beat 204B. In the intervening time, the star symbol has moved along its animation path, and is now positioned at the apex of its next bounce. In other words, between the first and second beats of the music path, the star symbol has fallen from the position shown in FIG. 2A, and then bounced up to the position shown in FIG. 2B, in time with the beats of the music track.

This animation effect has continued at the playback time depicted in FIG. 2C. As shown, the progress indicator has advanced to the third beat 204C. In the intervening time, the star symbol moved forward along its animation path and reached the apex of its next bounce. Thus, the star symbol has continued bouncing in time with the beats of the music track across the three playback positions depicted with respect to FIGS. 2A, 2B, and 2C.

As discussed above, it is generally desirable for animation effects to be consistently rendered even when a user “seeks” to arbitrary timestamps along the video timeline. This can sometimes be disrupted when, for instance, a user is playing the digital video track in the timeline of a video editor application after adding animation effects, and the user attempts to seek to an arbitrary timestamp along the timeline. By contrast, according to the techniques described herein, the animation effects may be accurately reproduced based on the animation start times, even when an arbitrary video timestamp is requested.

This is schematically illustrated with respect to FIG. 2D, in which the playback position of the video has been changed to a requested video timestamp, again represented by the position of the progress indicator 203 along the reference timeline 202. For instance, while reviewing the output video in a video editor application, the user may have manually changed the playback position of the video to the requested video timestamp. In response, the computing system determines the progress of the ongoing animation effect at the requested video timestamp based on the plurality of animation start times determined as described above. The computing system then displays a requested video frame (e.g., the video frame shown in FIG. 2D), with visual content consistent with the progress of the ongoing animation effect (e.g., the position of the star symbol along animation path 208). For instance, as shown, the star symbol is at an intermediary position between those depicted in FIGS. 2A and 2B, consistent with the intermediary playback position of the video between the first and second music beats.

The “progress” of the ongoing animation effect may be determined in any suitable way. As one non-limiting example, the animation start time of the ongoing animation effect (e.g., referred to as a “reference” start time for the purpose of this explanation) may be subtracted from the requested timestamp of the video. For instance, if the reference animation start time is 4 seconds, and the requested timestamp of the video is 5 seconds, then the ongoing animation effect begins one second prior to the requested timestamp. This resulting value may be divided by the total duration of the ongoing animation effect (e.g., two seconds) to determine the progress of the ongoing animation effect. Using the example values provided above, the current ongoing animation would have a progress of 0.5, or halfway through its current animation cycle. In the event that the progress is equal to one, this indicates that the ongoing animation had reached its final state at the requested timestamp, and may be represented accordingly.

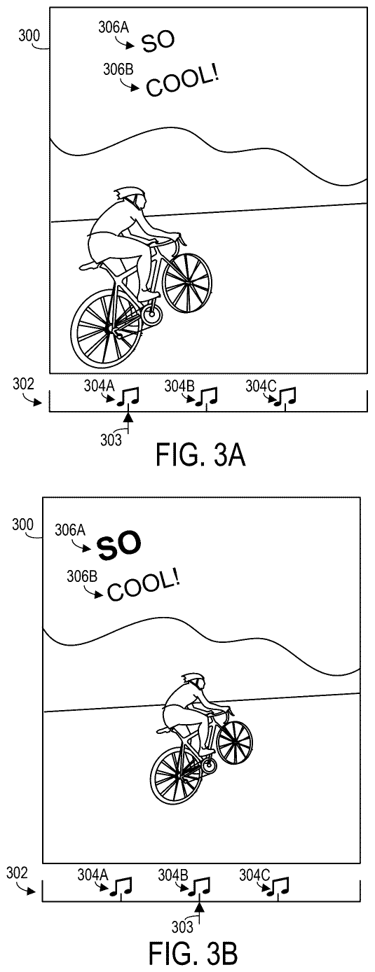

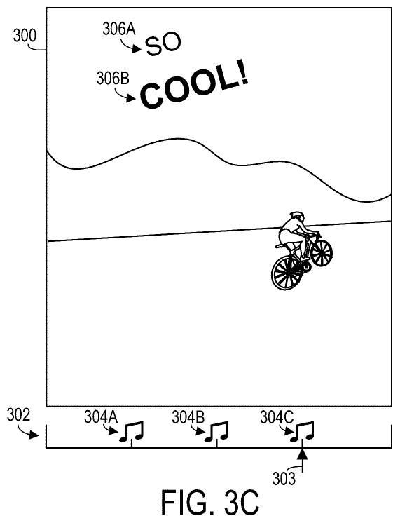

FIGS. 3A-3C depict another example scenario, where animation effects are applied to a plurality of text characters. Specifically, FIG. 3A, again shows an ongoing video 300, a reference timeline 302, a progress indicator 303, and beat indicators 304A, 304B, and 304C. Additionally, in this example, two different groups 306A and 306B of text characters are displayed as part of the video—e.g., forming the words “SO COOL!”. These represent different character groups as described above. In other words, the first character group 306A includes the characters “SO” and the second character group 306B includes the characters “COOL!”, and these different character groups may be animated separately as discussed above.

FIG. 3B shows another playback position of the video, in which the progress indicator has advanced from the first beat 304A to the second beat 304B. At this playback position, the size of the text characters in the first character group 306A has increased, and the font has been bolded. The text characters of the second character group 306B have not changed relative to the scenario depicted in FIG. 3A. In other words, this depicts an example where an animation effect is applied to one character group at the current playback position, and not to the other character group.

FIG. 3C shows another playback position of the video, in which the progress indicator has advanced from the second beat 304B to the third beat 304C. At this playback position, the text characters in the first character group 306A have returned to their original size and font boldness. The text characters of the second character group 306B have now increased in size and boldness. Thus, FIGS. 3A-C collectively illustrate a scenario where alternating animations are applied to the two different character groups—e.g., the two groups are enlarged and bolded on alternating beats of the music track.

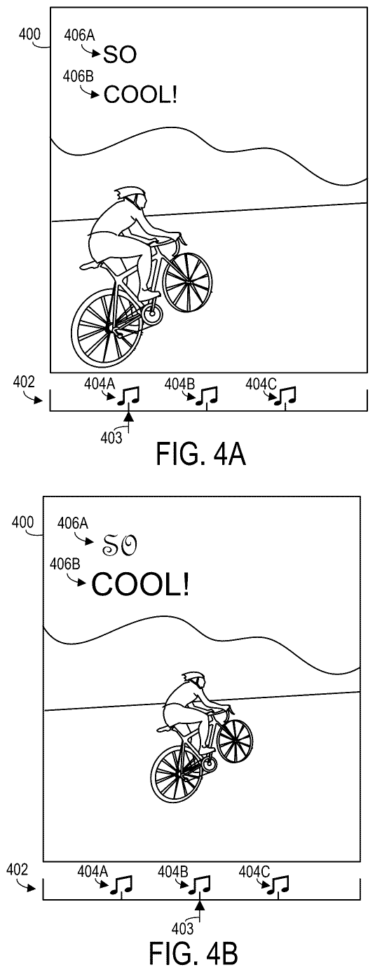

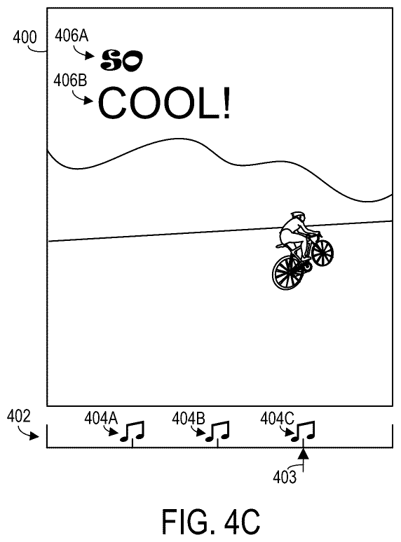

FIGS. 4A-4C depict another example scenario where animation effects are applied to a plurality of text characters. Similar to FIGS. 3A-C, FIG. 4A again shows an ongoing video 400, a reference timeline 402, a progress indicator 403, and beat indicators 404A, 404B, and 404C. Additionally, in this example, two different groups 406A and 406B of text characters are displayed as part of the video—e.g., forming the words “SO COOL!”, which again represent different character groups. In FIG. 4A, both character groups are depicted with the same size and font type.

FIG. 4B shows a playback position where the progress indicator has advanced from the first beat 404A to the second beat 404B. In this example, different animation effects have been applied to both character groups. Specifically, the font of the first character group has changed, while the size of the second character group has increased. These animation effects have continued at the playback position depicted in FIG. 4C, in which the font of the first character group has again changed, and the size of the second character group has again increased. In other words, FIGS. 4A-C collectively illustrate a scenario where two different animation effects are applied to two different character groups of text characters, and each of these animation effects are synchronized to the beats of the music track.

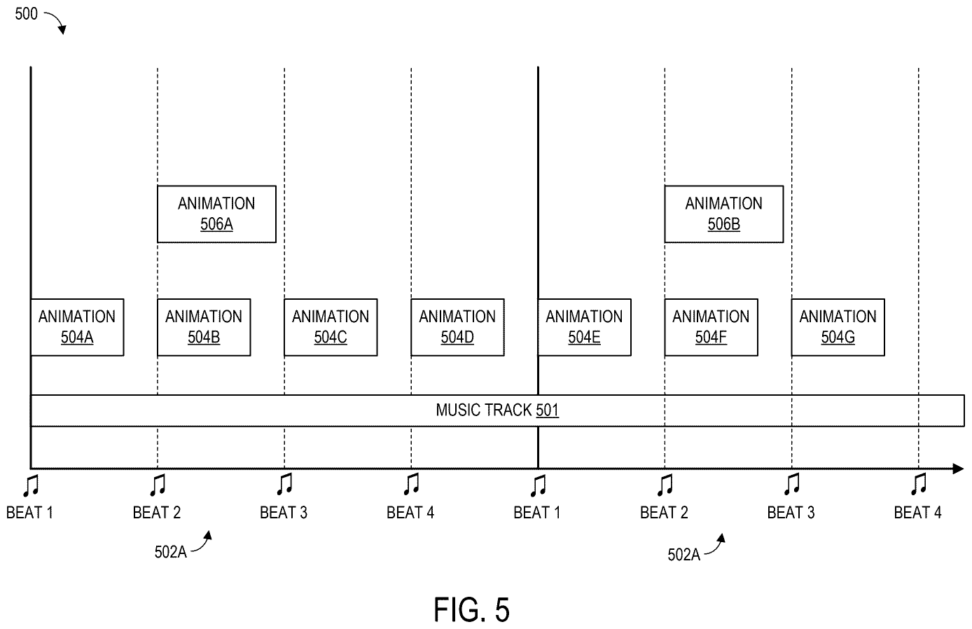

FIG. 5 depicts an example timeline 500, which illustrates the progress of a music track 501 over time, as it relates to the positions of a plurality of music beats and a plurality of different animation start times. In this example, the music beats have been divided into two different recurring beat patterns 502A and 502B, as discussed above. Each of these recurring beat patterns includes four beats, although this is non-limiting. The properties of the recurring beat pattern (e.g., the number of beats in a musical measure) may be specified in a beat array of the beat timing parameters as described with respect to FIG. 1B.

Additionally, FIG. 5 depicts a first plurality of animation start times 504A-G, and a second plurality of animation start times 506A and 506B. These correspond to two different animation effects. A first animation effect begins on each beat, and therefore corresponds to animation start times 504A-G. A second animation effect occurs only on the second beat of each recurring beat pattern, and thus corresponds to animation start times 506A and 506B. In other words, FIG. 5 illustrates a scenario where different beats have different positions within the recurring beat pattern, and different animation start times are specific to the different beat positions.

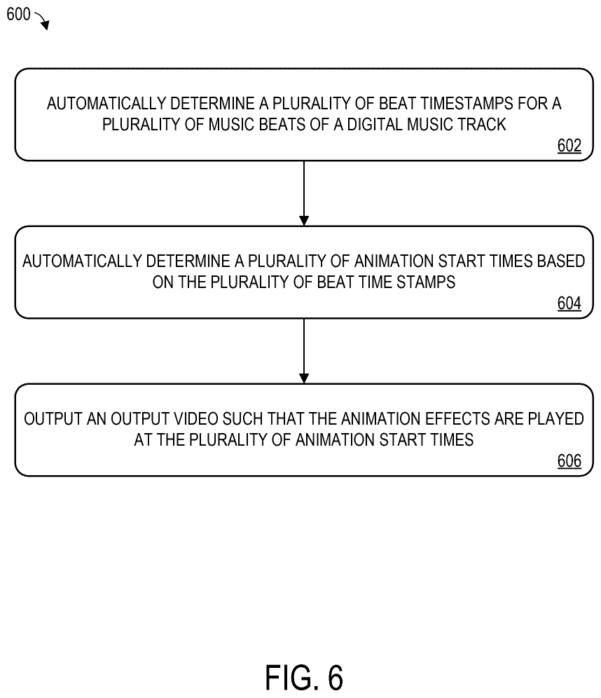

FIG. 6 illustrates an example method 600 for synchronizing music and animation effects during video playback. Steps of method 600 may be initiated, terminated, and/or looped at any suitable time and in response to any suitable condition. Method 600 may be implemented by any suitable computing system of one or more computing devices. Any computing device implementing steps of method 600 may have any suitable capabilities, hardware configuration, and form factor. In some examples, the computing system used to implement method 600 may be implemented as computing system 700 described below with respect to FIG. 7.

At 602, method 600 includes automatically determining a plurality of beat timestamps for a plurality of music beats of a digital music track. The digital music track is selected for concurrent playback with a digital video track as part of an output video. Furthermore, the beat timestamps are determined based at least in part on beat timing parameters for the music track. These may indicate the beat timestamps directly, and/or include information usable to derive the beat timestamps, such as the inter-beat time interval.

At 604, method 600 includes automatically determining, based on the plurality of beat timestamps, a plurality of animation start times for initiating one or more animation effects selected for inclusion as part of the output video. As discussed above, the animation effects may in some cases be applied to a plurality of text characters selected for display as part of the output video. Furthermore, the animation start times may have any suitable predefined relationship with respect to the beat timestamps, depending on the nature of each animation effect. For instance, some animation effects may begin on each beat, and some animation effects may be offset from each beat by a predefined amount of time.

At 606, method 600 includes outputting an output video based on the digital video track, the digital music track, and the one or more animation effects. The video, music, and animation effects are synchronized such that the one or more animation effects are played at the plurality of animation start times during the playback of the output video. Notably, such synchronization was performed automatically by the computing system, based on the selected music track and the selected animation effects. In other words, the techniques discussed herein beneficially enable synchronization of music and animation effects while reducing the burden placed on human users, particularly those without significant experience using video editing software.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 7 schematically shows a non-limiting embodiment of a computing system 700 that can enact one or more of the methods and processes described above. Computing system 700 is shown in simplified form. Computing system 700 may embody the computer device 10 described above and illustrated in FIG. 2. Computing system 700 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 700 includes a logic processor 702 volatile memory 704, and a non-volatile storage device 706. Computing system 700 may optionally include a display subsystem 708, input subsystem 710, communication subsystem 712, and/or other components not shown in FIG. 7.

Logic processor 702 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 702 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 706 includes one or more physical devices configured to hold instructions executable by the logic processors to implement the methods and processes described herein. When such methods and processes are implemented, the state of non-volatile storage device 706 may be transformed—e.g., to hold different data.

Non-volatile storage device 706 may include physical devices that are removable and/or built-in. Non-volatile storage device 706 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 706 may include nonvolatile, dynamic, static, read/write, read-only, sequential-access, location-addressable, file-addressable, and/or content-addressable devices. It will be appreciated that non-volatile storage device 706 is configured to hold instructions even when power is cut to the non-volatile storage device 706.

Volatile memory 704 may include physical devices that include random access memory. Volatile memory 704 is typically utilized by logic processor 702 to temporarily store information during processing of software instructions. It will be appreciated that volatile memory 704 typically does not continue to store instructions when power is cut to the volatile memory 704.

Aspects of logic processor 702, volatile memory 704, and non-volatile storage device 706 may be integrated together into one or more hardware-logic components. Such hardware-logic components may include field-programmable gate arrays (FPGAs), program-and application-specific integrated circuits (PASIC/ASICs), program-and application-specific standard products (PSSP/ASSPs), system-on-a-chip (SOC), and complex programmable logic devices (CPLDs), for example.

The terms “module,” “program,” and “engine” may be used to describe an aspect of computing system 700 typically implemented in software by a processor to perform a particular function using portions of volatile memory, which function involves transformative processing that specially configures the processor to perform the function. Thus, a module, program, or engine may be instantiated via logic processor 702 executing instructions held by non-volatile storage device 706, using portions of volatile memory 704. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 708 may be used to present a visual representation of data held by non-volatile storage device 706. The visual representation may take the form of a graphical user interface (GUI). As the herein described methods and processes change the data held by the non-volatile storage device, and thus transform the state of the non-volatile storage device, the state of display subsystem 708 may likewise be transformed to visually represent changes in the underlying data. Display subsystem 708 may include one or more display devices utilizing virtually any type of technology. Such display devices may be combined with logic processor 702, volatile memory 704, and/or non-volatile storage device 706 in a shared enclosure, or such display devices may be peripheral display devices.

When included, input subsystem 710 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on-or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 712 may be configured to communicatively couple various computing devices described herein with each other, and with other devices. Communication subsystem 712 may include wired and/or wireless communication devices compatible with one or more different communication protocols. As non-limiting examples, the communication subsystem may be configured for communication via a wireless telephone network, or a wired or wireless local-or wide-area network, such as a HDMI over Wi-Fi connection. In some embodiments, the communication subsystem may allow computing system 700 to send and/or receive messages to and/or from other devices via a network such as the Internet.

The following paragraphs provide additional description of the subject matter of the present disclosure.

In an example, a method for synchronizing music and animation effects in a video comprises: at a computing system, automatically determining, based on one or more music beat timing parameters for a music track, a plurality of beat timestamps for a plurality of music beats of the music track, wherein the music track is selected for concurrent playback with a video track as part of an output video; automatically determining, based on the plurality of beat timestamps, a plurality of animation start times for initiating one or more animation effects selected for playback as part of the output video; and outputting the output video based at least in part on the video track, the music track, and the one or more animation effects, wherein the music track, the video track, and the one or more animation effects are synchronized such that the one or more animation effects are played at the plurality of animation start times during playback of the output video. In this example or any other example, the one or more animation effects are applied to a plurality of text characters selected for display as part of the output video. In this example or any other example, the plurality of text characters are divided into two or more character groups, and the one or more animation effects are applied to the two or more character groups at different animation start times of the plurality of animation start times. In this example or any other example, the plurality of text characters are divided into two or more character groups, and the one or more animation effects include two or more animation effects, such that different animation effects are applied to each character group. In this example or any other example, the one or more animation effects include one or more of changing a size, a shape, a position, an orientation, a color, an opacity, and a font type of the plurality of text characters. In this example or any other example, the method further comprises receiving a selection of a requested video timestamp of the video track, determining a progress of an ongoing animation effect of the one or more animation effects at the requested video timestamp based on the plurality of animation start times, and displaying a requested video frame corresponding to the requested video timestamp with visual content consistent with the progress of the ongoing animation effect. In this example or any other example, the ongoing animation effect is associated with a reference animation start time of the plurality of animation start times, and wherein the progress of the ongoing animation effect is calculated by subtracting the reference animation start time from the requested video timestamp, and dividing a resulting value by a total duration of the ongoing animation effect. In this example or any other example, the one or more music beat timing parameters for the music track include one or more of a duration of the music track, a start time of the music track, an end time of the music track, a time interval between each music beat of the plurality of music beats, and a beat array of the plurality of music beats. In this example or any other example, different music beats of the plurality of music beats have different positions within a recurring beat pattern specified by the beat array, and wherein different animation times of the plurality of animation start times are specific to different beat positions of the recurring beat pattern. In this example or any other example, the one or more animation effects are applied to the video track by an animation effects renderer of the computing system, and wherein the animation effects renderer receives the plurality of animation start times via an application programming interface (API).

In an example, a computing system comprises: a processor; and a storage device holding instructions executable by the processor to: automatically determine, based on one or more music beat timing parameters for a music track, a plurality of beat timestamps for a plurality of music beats of the music track, wherein the music track is selected for concurrent playback with a video track as part of an output video; automatically determining, based on the plurality of beat timestamps, a plurality of animation start times for initiating one or more animation effects selected for playback as part of the output video; and outputting the output video based at least in part on the video track, the music track, and the one or more animation effects, wherein the music track, the video track, and the one or more animation effects are synchronized such that the one or more animation effects are played at the plurality of animation start times during playback of the output video. In this example or any other example, the one or more animation effects are applied to a plurality of text characters selected for display as part of the output video. In this example or any other example, the plurality of text characters are divided into two or more character groups, and the one or more animation effects are applied to the two or more character groups at different animation start times of the plurality of animation start times. In this example or any other example, the plurality of text characters are divided into two or more character groups, and the one or more animation effects include two or more animation effects, such that different animation effects are applied to each character group. In this example or any other example, the one or more animation effects include one or more of changing a size, a shape, a position, an orientation, a color, an opacity, and a font type of the plurality of text characters. In this example or any other example, the instructions are further executable to receive a selection of a requested video timestamp of the video track, determine a progress of an ongoing animation effect of the one or more animation effects at the requested video timestamp based on the plurality of animation start times, and display a requested video frame corresponding to the requested video timestamp with visual content consistent with the progress of the ongoing animation effect. In this example or any other example, the ongoing animation effect is associated with a reference animation start time of the plurality of animation start times, and wherein the progress of the ongoing animation effect is calculated by subtracting the reference animation start time from the requested video timestamp, and dividing a resulting value by a total duration of the ongoing animation effect. In this example or any other example, the one or more music beat timing parameters for the music track include one or more of a duration of the music track, a start time of the music track, an end time of the music track, a time interval between each music beat of the plurality of music beats, and a beat array of the plurality of music beats. In this example or any other example, different music beats of the plurality of music beats have different positions within a recurring beat pattern specified by the beat array, and wherein different animation times of the plurality of animation start times are specific to different beat positions of the recurring beat pattern.

In an example, a method for synchronizing music and animation effects in a video comprises: at a computing system, automatically determining, based on one or more music beat timing parameters for a music track, a plurality of beat timestamps for a plurality of music beats of the music track, wherein the music track is selected for concurrent playback with a video track as part of an output video; receiving a plurality of text characters to be displayed as part of the output video; automatically determining, based on the plurality of beat timestamps, a plurality of animation start times for initiating one or more text animation effects to be applied to the plurality of text characters; and outputting the output video based at least in part on the video track, the music track, the plurality of text characters, and the one or more text animation effects, wherein the music track, the video track, and the one or more text animation effects are synchronized such that the one or more animation effects are applied to the plurality of text characters at the plurality of animation start times during playback of the output video.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for synchronizing music and animation effects in a video, the method comprising:
at a computing system, automatically determining, based on one or more music beat timing parameters for a music track, a plurality of beat timestamps for a plurality of music beats of the music track, wherein the music track is selected for concurrent playback with a video track as part of an output video;
automatically determining, based on the plurality of beat timestamps, a plurality of animation start times for initiating one or more animation effects selected for playback as part of the output video; and
outputting the output video based at least in part on the video track, the music track, and the one or more animation effects, wherein the music track, the video track, and the one or more animation effects are synchronized such that the one or more animation effects are played at the plurality of animation start times during playback of the output video.

2. The method of claim 1, wherein the one or more animation effects are applied to a plurality of text characters selected for display as part of the output video.

3. The method of claim 2, wherein the plurality of text characters are divided into two or more character groups, and the one or more animation effects are applied to the two or more character groups at different animation start times of the plurality of animation start times.

4. The method of claim 2, wherein the plurality of text characters are divided into two or more character groups, and the one or more animation effects include two or more animation effects, such that different animation effects are applied to each character group.

5. The method of claim 2, wherein the one or more animation effects include one or more of changing a size, a shape, a position, an orientation, a color, an opacity, and a font type of the plurality of text characters.

6. The method of claim 1, further comprising receiving a selection of a requested video timestamp of the video track, determining a progress of an ongoing animation effect of the one or more animation effects at the requested video timestamp based on the plurality of animation start times, and displaying a requested video frame corresponding to the requested video timestamp with visual content consistent with the progress of the ongoing animation effect.

7. The method of claim 6, wherein the ongoing animation effect is associated with a reference animation start time of the plurality of animation start times, and wherein the progress of the ongoing animation effect is calculated by subtracting the reference animation start time from the requested video timestamp, and dividing a resulting value by a total duration of the ongoing animation effect.

8. The method of claim 1, wherein the one or more music beat timing parameters for the music track include one or more of a duration of the music track, a start time of the music track, an end time of the music track, a time interval between each music beat of the plurality of music beats, and a beat array of the plurality of music beats.

9. The method of claim 8, wherein different music beats of the plurality of music beats have different positions within a recurring beat pattern specified by the beat array, and wherein different animation times of the plurality of animation start times are specific to different beat positions of the recurring beat pattern.

10. The method of claim 1, wherein the one or more animation effects are applied to the video track by an animation effects renderer of the computing system, and wherein the animation effects renderer receives the plurality of animation start times via an application programming interface (API).

11. A computing system, comprising:
a processor; and
a storage device holding instructions executable by the processor to:
automatically determine, based on one or more music beat timing parameters for a music track, a plurality of beat timestamps for a plurality of music beats of the music track, wherein the music track is selected for concurrent playback with a video track as part of an output video;
automatically determining, based on the plurality of beat timestamps, a plurality of animation start times for initiating one or more animation effects selected for playback as part of the output video; and
outputting the output video based at least in part on the video track, the music track, and the one or more animation effects, wherein the music track, the video track, and the one or more animation effects are synchronized such that the one or more animation effects are played at the plurality of animation start times during playback of the output video.

12. The computing system of claim 11, wherein the one or more animation effects are applied to a plurality of text characters selected for display as part of the output video.

13. The computing system of claim 12, wherein the plurality of text characters are divided into two or more character groups, and the one or more animation effects are applied to the two or more character groups at different animation start times of the plurality of animation start times.

14. The computing system of claim 12, wherein the plurality of text characters are divided into two or more character groups, and the one or more animation effects include two or more animation effects, such that different animation effects are applied to each character group.

15. The computing system of claim 12, wherein the one or more animation effects include one or more of changing a size, a shape, a position, an orientation, a color, an opacity, and a font type of the plurality of text characters.

16. The computing system of claim 11, wherein the instructions are further executable to receive a selection of a requested video timestamp of the video track, determine a progress of an ongoing animation effect of the one or more animation effects at the requested video timestamp based on the plurality of animation start times, and display a requested video frame corresponding to the requested video timestamp with visual content consistent with the progress of the ongoing animation effect.

17. The computing system of claim 16, wherein the ongoing animation effect is associated with a reference animation start time of the plurality of animation start times, and wherein the progress of the ongoing animation effect is calculated by subtracting the reference animation start time from the requested video timestamp, and dividing a resulting value by a total duration of the ongoing animation effect.

18. The computing system of claim 11, wherein the one or more music beat timing parameters for the music track include one or more of a duration of the music track, a start time of the music track, an end time of the music track, a time interval between each music beat of the plurality of music beats, and a beat array of the plurality of music beats.

19. The computing system of claim 18, wherein different music beats of the plurality of music beats have different positions within a recurring beat pattern specified by the beat array, and wherein different animation times of the plurality of animation start times are specific to different beat positions of the recurring beat pattern.

20. A method for synchronizing music and animation effects in a video, the method comprising:
at a computing system, automatically determining, based on one or more music beat timing parameters for a music track, a plurality of beat timestamps for a plurality of music beats of the music track, wherein the music track is selected for concurrent playback with a video track as part of an output video;
receiving a plurality of text characters to be displayed as part of the output video;
automatically determining, based on the plurality of beat timestamps, a plurality of animation start times for initiating one or more text animation effects to be applied to the plurality of text characters; and
outputting the output video based at least in part on the video track, the music track, the plurality of text characters, and the one or more text animation effects, wherein the music track, the video track, and the one or more text animation effects are synchronized such that the one or more animation effects are applied to the plurality of text characters at the plurality of animation start times during playback of the output video.
